(19) United States
(12) Patent Application Publication
(10) Pub. No.: US 2010/0194643 A1
(43) Pub. Date: Aug. 5, 2010

(54) WIDEBAND PATCH ANTENNA WITH HELIX OR THREE DIMENSIONAL FEED

(75) Inventor: ARGY PETROS, Parkland, FL (US)

Correspondence Address: Guntin Meles & Gust, PLC, 304 Indian Trace, #750, Weston, FL, 33326, US

(73) Assignee: THINK WIRELESS, INC., Parkland, FL (US)

(21) Appl. No.: 12/365,009

(22) Filed: Feb. 3, 2009

(51) Int. Cl. H01Q 1/38; H01Q 1/48; H01Q 21/00

(52) U.S. Cl. 343/700 MS; 343/848; 343/893

(57) ABSTRACT

A wideband patch antenna (90) is presented that comprises a patch (91) which is of pure metallic form or etched on a dielectric, that may be rectangular, elliptical, triangular, or any other shape. The patch is disposed a distance above a ground plane (92) and is driven by a helix-shaped or a three-dimensional probe (94) disposed between the patch and the ground plane. The probe is substantially normal to the ground plane. In addition, a plurality of such patch antennas may be combined to form antenna arrays or dual-band antenna structures.

### FIELD OF THE INVENTION

The embodiments herein relate to a patch antenna, and in particular to a wideband patch antenna fed by a helix-shape. The embodiments herein can further relate to antenna arrays or dual band structures comprising a plurality of such patch antennas.

### BACKGROUND OF THE INVENTION

Microstrip patch antennas are very popular for a wide variety of applications. They have several advantages such as low profile, low cost, simple fabrication and light weight that make them very suitable in fixed and mobile communication systems. A typical microstrip patch antenna comprises a patch above a ground plane and separated from the ground plane by a dielectric. A typical patch is fed by means of a coaxial feed, where the center conductor pin is physically connected to the patch. One drawback with such microstrip patch antennas is that they have a relatively narrow bandwidth and thus, are not generally suitable for applications requiring broad bandwidth. The bandwidth can be increased by increasing the substrate thickness and decreasing the substrate permittivity. Relatively large bandwidth can be obtained by suspending the patch in air and increasing the antenna thickness or in other words increasing the distance from patch antenna to ground plane. However, the increase in thickness increases the coaxial probe inductance due to increased probe length, thus, limiting the antenna bandwidth. Several methods have been disclosed that reduce or compensate for this additional probe inductance while increasing the bandwidth of relatively thick microstrip patch antennas. These methods, as well as, our claimed method, will be described next.

Method 1: (Sabbin A. “A new broadband stacked two-layer microstrip antenna”, IEEE AP-S Int. Sym. Digest, 1983, 63-66) and (Lee, R. Q., Lee, K. F., Bobinchak, J. “Two-layer electromagnetically coupled rectangular patch antenna”, Antennas and Propagation Society International Symposium, 1988, AP-S. Digest, Vol. 3, pp 948-951). A second parasitic patch on top of the driven patch electromagnetically coupled to the driven patch. The use of a parasitic patch on top or next to the driven patch increases the overall thickness and volume of the antenna, and cost.

Method 2: (Fong K. S., Pues H. F., Withers M. J. “Wideband multiple layer coaxial fed microstrip antenna element”, Electron Lett, 1985, 21, pp 497-499.) This method utilizes a capacitively coupled feed where a conductive disk, etched on a substrate, is attached to the top section of the feed and spaced a small distance below the patch. The capacitively coupled feed, although neutralizing the extra probe inductance, is a high-cost complex structure and requires high precision, thus increasing cost.

Method 3: (Pozar D. “A reciprocity method of analysis for printed slot and slot-coupled microstrip antennas”, IEEE Transactions on Antennas and Propagation, Vol. 34, December 1986, pp 1439-1446) and (Pozar D. M., Targonski, S. D. “Improved coupling for aperture coupled microstrip antennas”, Electronics Letters, Vol. 27, Issue 13, June 1991, pp 1129-1131). This approach utilizes aperture coupling using a slot and a microstrip line for feeding the patch. The slot/microstrip line approach requires an additional substrate where the slot and microstrip line are etched. This solution also increases cost and assembly time.

Method 4: (Hall P. S. “Probe Compensation in Thick Microstrip Patches” Electronic Letters, Vol. 23, No. 11, 1987, pp 606-607). A conductive disk is attached at the end of the feed just like method 2 described above. In this case, the disk and driven patch are located on the same layer forming an annular gap between them, thus forming a capacitor. This annular gap increases the probe capacitance required to reduce the extra probe inductance. However, the antenna radiation pattern exhibits cross-polar components (Garg et al., “Microstrip Antenna Design Handbook, ISBN 0-89006-513-6, 2001 Artech House, Inc. page 19). In addition, this arrangement results in a complex structure, especially when the patch and disk are suspended in air, thus, increasing cost.

Method 5: (Hall P. S., Dahele J. S., Haskins P. M. “Microstrip patch antennas on thick microstrip patches”, Antennas and Propagation Society International Symposium, 1989, AP-S. Digest, Vol. 1, June 1989, pp 458-462). A capacitor is formed by placing a small conductive disk at the end of the feed, just like methods 2 and 4. The conductive disk is placed on top of the patch and separated from the top surface of the patch by a small gap, thus, creating the required capacitance. This extra capacitance compensates for the additional probe inductance, thus increasing the antenna bandwidth. However, this approach also results in a complex structure and high cost.

Method 6: (Luk K. M., Chow Y., Mak L., U.S. Pat. No. 6,593,887, Jul. 15, 2003). The inventors describe a patch antenna using an L-shaped feed probe. The L-shaped probe has a first portion normal to ground plane and patch, and a second portion parallel to ground plane and patch. The L-shaped probe is electromagnetically coupled to the patch. This arrangement is also effective in reducing the extra inductance of the probe. However, the total physical length of the probe is relatively large, approximately ¼ of the wavelength (i.e., 8.72 cm at 860 MHz). This large size can cause interference and EMI problems with RF circuits located in the vicinity of the probe. In addition, since the horizontal component of the L-shaped probe is much longer than the vertical section of the probe, it will be difficult to implement a two-feed circularly polarized patch antenna. More particularly, the two probes may interfere with each other due to their close proximity. Furthermore, the long horizontal probe requires means of mechanical support which once again increases the cost and design complexity of the structure.

Method 7: (Luk; Kwai-Man, Lai; Hau Wah, U.S. Pat. No. 7,119,746, Oct. 10, 2006).

The inventors describe a patch antenna using a meandering feed probe. The meandering probe is electromagnetically coupled to the patch. This arrangement is also effective in reducing the extra inductance of the probe. However, such structure is still physically large for lower frequency applications. Just as in method 6, this large size can cause interference and electromagnetic interference (EMI) problems with RF circuits located in the vicinity of the probe.

None of the solutions described above provide a simple, compact, and low-cost feed system resulting in wide frequency bandwidth.

### SUMMARY OF THE INVENTION

According to the embodiments an antenna as contemplated herein can comprise a patch which is of pure metallic form or etched on a dielectric and is disposed by a dielectric a distance above a ground plane, and a helix-shaped or meandering probe that meanders over multiple planes or in a three dimensional space disposed between the patch and the ground plane where the probe is normal to the ground plane. The antenna can further comprise a connector, a transmission line or coaxial line center conductor that couples the probe to a transmitter to or from the antenna, and the probe is adapted to be electromagnetically coupled to the patch. The patch may be rectangular, elliptical, triangular, or any other geometric or irregular shape.

In one embodiment, an antenna can comprise a rectangular patch suspended in air above a ground plane by a distance h, and a helical or three dimensional probe disposed between the patch and the ground plane, the probe is substantially normal to the ground plane and the patch, and spaced from one edge of the patch by a distance d, the antenna further comprising a connector coupling the probe to a transmitter to or from the antenna. The probe may consist of several turns or a fractional turn depending on its diameter. Generally, smaller diameters result in more turns.

The helix probe, according to the present embodiments, does not exhibit the additional inductance problem present by other methods or structures, resulting in wideband patch antenna structures. For example, the capacitance between neighboring wires neutralizes the extra inductance caused by the increase of wire length.

The antenna may be a single antenna with one patch and one probe according to the present embodiments. However, viewed from another aspect, a plurality of antennas according to the present embodiments can form an antenna array comprising a plurality of patches disposed above a ground plane, each patch having a respective probe disposed between the patch and the ground plane, the antenna array further comprising a transmission network connecting the probes to each other and to a transmitter or a means for transmitting a signal to or from the antenna array. Such an antenna array may take several forms. One simple structure is an array that comprises two patches with their respective probes being connected by a single transmission line. The arrays can use one type or combination of the probes according to the present embodiments. Antenna arrays such as a two-by-two or four-by-four array may be formed. More complicated arrays may also be formed.

Another example is a dual band antenna structure. A particular example of such structure comprises two rectangular patches and two respective probes, both patches and probes are of different dimensions. The patches are disposed above a ground plane and spaced at different distances from the ground plane. The dual band antenna structure further comprises a transmission line connecting said probes to each other and to means for transmitting a signal to or from said antenna structure, said transmission line being parallel to said ground plane.

It will also be understood that the patch antennas may be spaced from the ground plane by any form of dielectric material (including air) or by multiple layers of differing dielectric materials.

### BRIEF DESCRIPTION OF THE DRAWINGS

FIG. 1 is a diagram that illustrates a conventional patch antenna with a feed probe directly connected to the patch.

FIG. 2 is a diagram of a stacked patch antenna arrangement.

FIG. 3 is a diagram of a wideband patch antenna using a disk-loaded feed probe spaced below the patch.

FIG. 4 is a diagram of a conventional aperture-coupling patch antenna.

FIG. 5 is a diagram of a wideband patch antenna using a disk-loaded feed probe.

FIG. 6 is a diagram of a wideband patch antenna using a disk-loaded feed probe spaced above the patch.

FIG. 7 is a diagram of a wideband patch antenna using an L-shaped feed probe spaced below the patch.

FIG. 8 is a diagram of a wideband patch antenna according to the present invention, using a helix-shaped probe.

FIG. 9 is a diagram of a wideband patch antenna according to the present invention, using a planar meandering-wire probe.

FIG. 10 is a diagram according to the present invention, showing two types of helical feed probes.

### DETAILED DESCRIPTION OF THE DRAWINGS

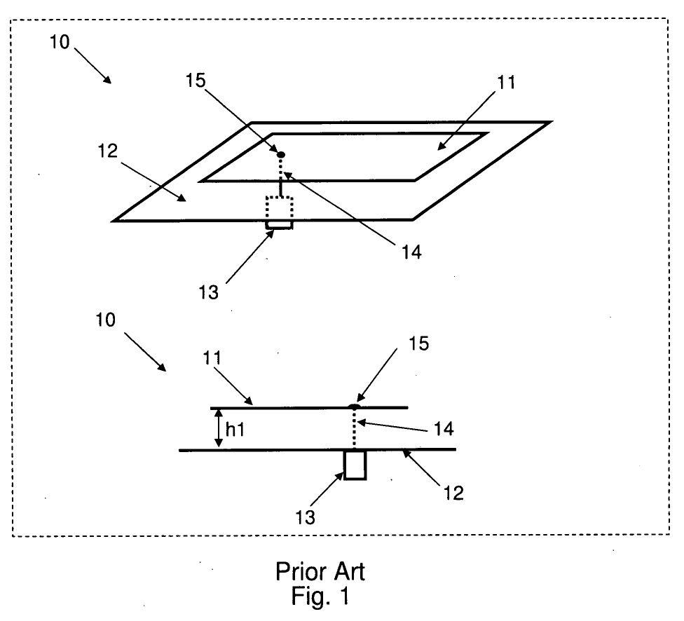

FIG. 1 shows a perspective and side view of a standard patch antenna 10, where patch 11 is suspended in air a distance hi above ground plane 12. Patch 11 is fed by means of a coaxial connector 13, where its center conductor probe 14 is physically connected to the patch at feed point 15.

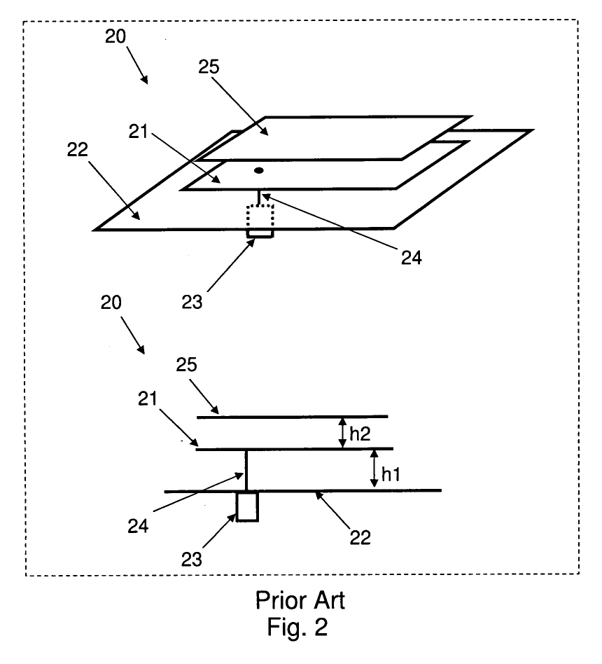

FIG. 2 illustrates method 1 described above. It shows a perspective and side view of a stacked patch antenna assembly 20. Patch 21 is suspended in air a distance h1 above ground plane 22. Patch 21 is fed by means of a coaxial connector 23, where its center conductor probe 24 is physically connected to patch 21. A second patch 25 is placed a distance h2 above patch 21.

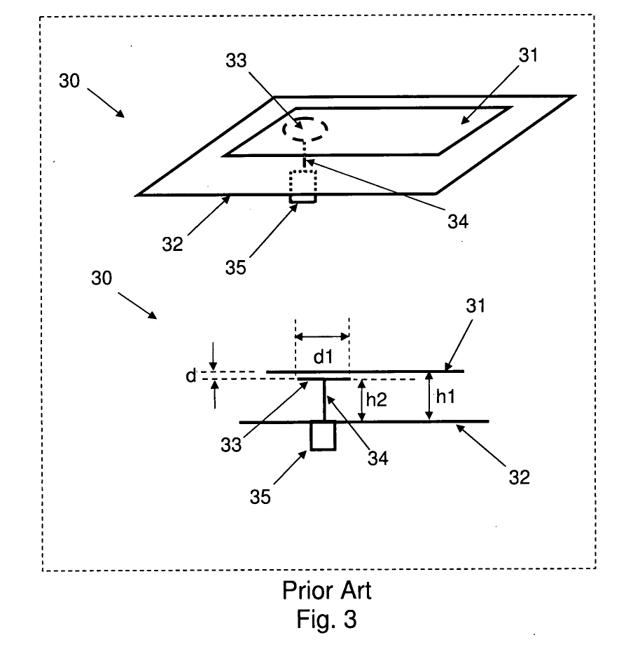

FIG. 3 illustrates method 2. It shows a perspective and side view of a wideband patch antenna assembly, 30, that utilizes a disk-loaded feed probe. Patch 31 is suspended in air a distance h1 above ground plane 32. Conductive disk 33, etched on a substrate, is attached to the top section of center conductor probe 34 of coaxial connector 35. Disk 33 has diameter d1 and is spaced at a height h2 above ground plane 32 and a small distance d below patch 31. Typical dimensions at a frequency of 1900 MHz are: patch 301: 6.5 cm×6.5 cm, h1=1 cm, d1=1 cm, d=0.08 cm.

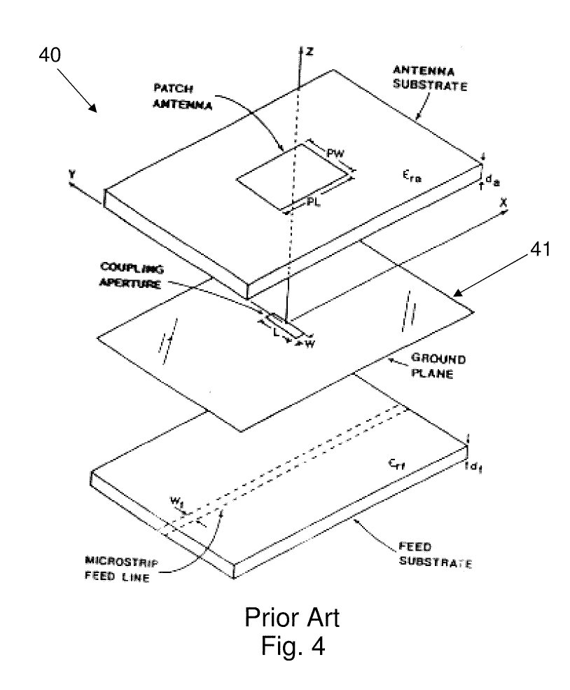

FIG. 4 shows an exploded view of an aperture coupling patch assembly, 40, according to method 3. The microstrip feed line is etched on the feed substrate and can be connected to a coaxial connector or cable. The coupling aperture is on ground plane 41. The patch antenna is etched on a dielectric and placed above ground plane 41.

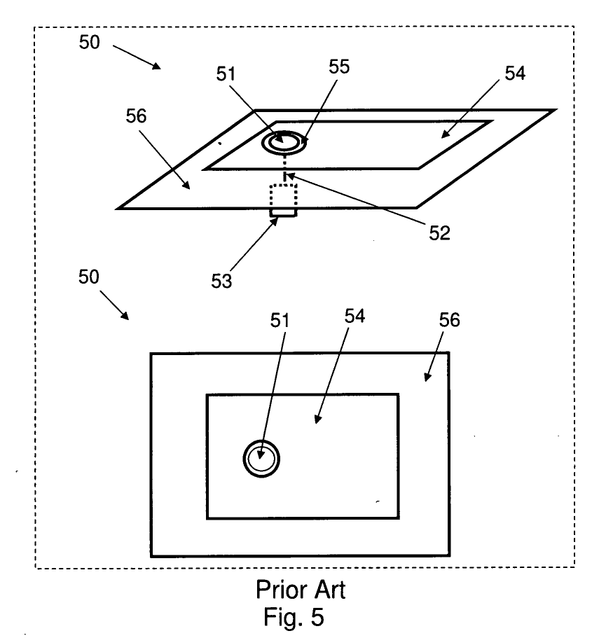

FIG. 5 shows a perspective and top view of a patch antenna assembly, 50, according to method 4. Conductive disk 51 is attached to the end of the coaxial center conductor probe 52 of coaxial connector 53. A hole in the patch allows disk 51 to be located on the same plane as patch 54 and same distance h from ground plane 56. An annular gap 55 is formed between disk 51 and patch 54.

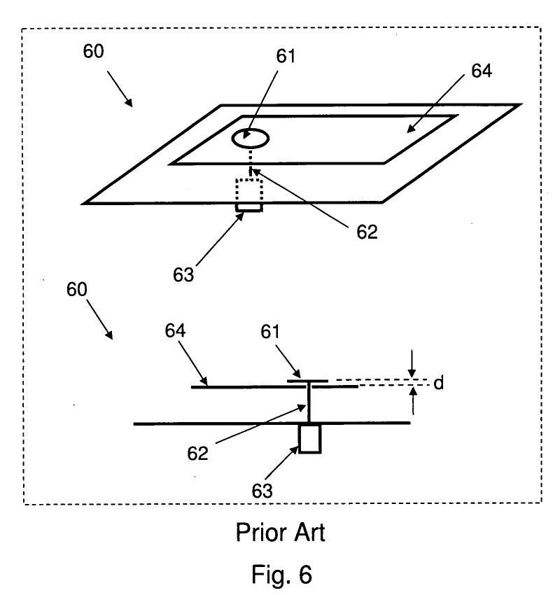

FIG. 6 illustrates a perspective and side view of a patch antenna assembly, 60, according to method 5. Conductive disk 61 is attached to the end of the coaxial center conductor probe 62 of coaxial connector 63, identical to methods 2 and 5. In this case, disk 61 is spaced above patch 64 by a distance d.

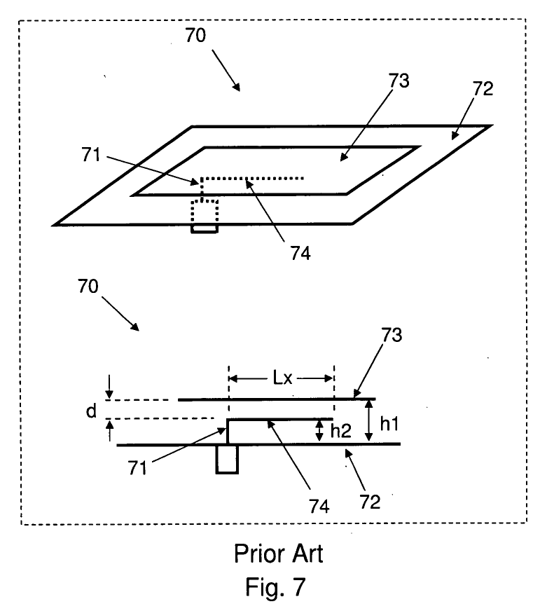

FIG. 7 shows a perspective and side view of an patch antenna assembly, 70, according to method 6. The L-shaped probe has a first portion 71 normal to ground plane 72 and patch 73, and a second portion 74 parallel to ground plane and patch. Horizontal section 74 of the probe is at a distance h2 above ground plane 72 and distance d from patch 73.

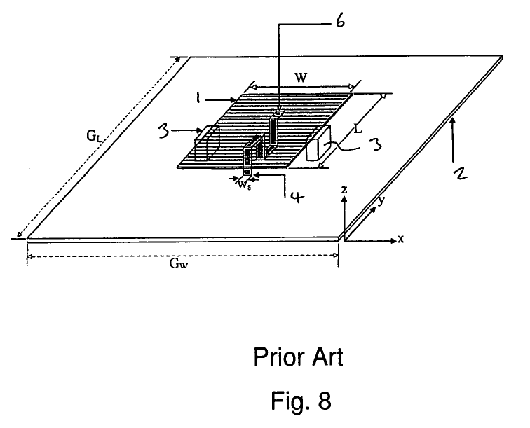

FIG. 8 shows a perspective view of a patch antenna assembly according to method 7. This method still results in physically large feeds, especially on low frequency applications.

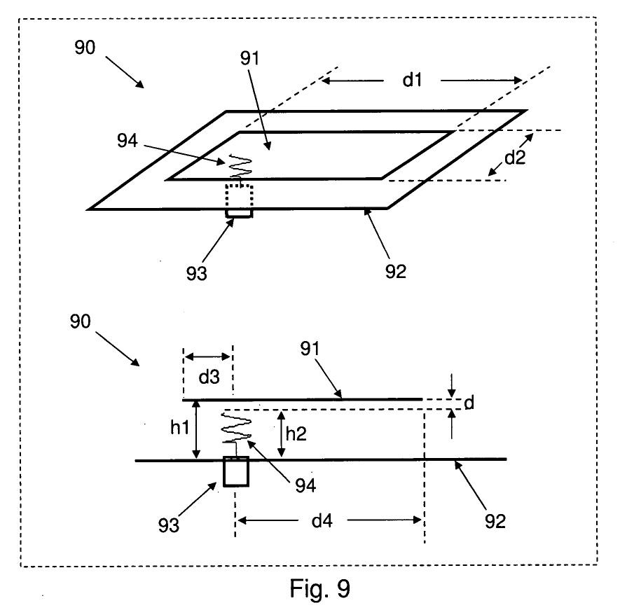

FIG. 9 is perspective view and a side view of a wideband patch antenna assembly, 90, according to the embodiments herein. Patch 91 is suspended in air a distance h1 above ground plane 92. Patch 91 has dimensions of d1 by d2 and is fed by means of a coaxial connector 93, where its center conductor is connected to a helix 94. Helix 94 is placed underneath patch 91. The tallest or highest point of helix 94 is at a small distance d from the bottom surface of patch 91. Helix 94 is at a distance d3 from one edge of patch 91 and d4 from the other edge of patch 91. Distance d4 is significantly larger than distance d3. Distance d3 can also be 0 mm. In some cases the helix probe does not have to be directly below patch 91 but can be placed outside the patch antenna. The height of helix 94 is h2 and it may consist of several turns or a fractional turn depending of its diameter. Typical dimensions for a patch antenna according to a particular embodiment operating at 1840 MHz can be: ground plane=12 cm×12 cm, patch=6.7×6.7 cm, patch height=0.95 cm, helix height=0.75 cm, distance d=2 mm, helix diameter=1 cm, number of turns=1.3, wire diameter=0.5 mm. These particular dimensions result in a 13% bandwidth.

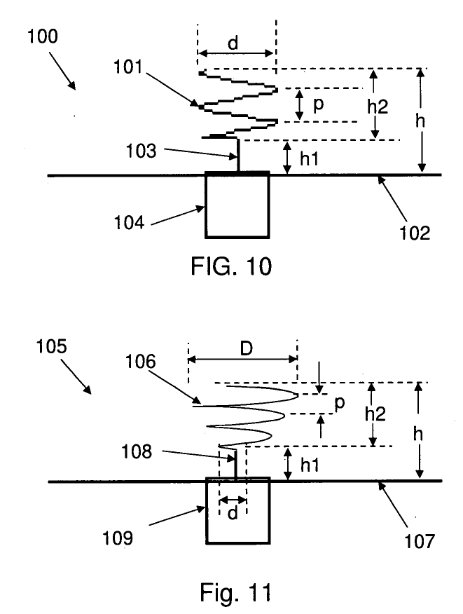

FIG. 10 shows a standard helix probe 100. Helix 101 is placed above ground plane 102 and is connected to a short vertical section 103 of height h1 that is an extension of the center conductor of coaxial connector 104. The helix parameters are: diameter d, pitch p, number of turns, and height h2. The height of the total probe assembly is h.

FIG. 11 shows a conical helix probe 105. Conical helix 106 is placed above ground plane 107 and is connected to a short vertical section 108 of height h1 that is an extension of the center conductor of coaxial connector 109. The helix parameters are: bottom helix diameter d, top helix diameter D, pitch p, number of turns, and height h2. The height of the total probe assembly is h.

It should be noted that the embodiments described herein should not limit the scope of the claimed embodiments. The description above is intended by way of example only and is not intended to limit the present scope in any way except as set forth in the following claims. For example, the probes according to the present embodiments can be connected to a transmission line or coaxial cable in addition to a coaxial connector. The coaxial cable shield may be soldered to the bottom side of the ground plane and the cable center conductor can connect to the probe through a hole on the ground plane. The coaxial cable shield may also be soldered to the top side of the ground plane and the cable center conductor can connect to the probe without the need for a hole on the ground plane. It shall be understood, that the patch antennas may be of pure metallic form or etched on any type of dielectric. In addition, as mentioned above, the patch antennas may be spaced from the ground plane by any form of dielectric material (including air) or by multiple layers of differing dielectric materials. The probe can be any type of helix element such as a standard helix, conical, and square helix.

1. An antenna comprising:
a patch antenna disposed above a ground plane, and
a probe disposed between the patch and the ground plane, the probe having a helical or three dimensional shape occupying multiple planes and being substantially normal to the ground plane.

2. The antenna of claim 1, wherein the antenna further comprises a connector, a transmission line, or a coaxial line center conductor constructed to couple the probe to a transmitter to or from the antenna, wherein said probe is adapted to be electromagnetically coupled to the patch.

3. The antenna of claim 1, wherein the antenna is a portion of a plurality of antennas forming an antenna array comprising a plurality of patch antenna disposed above a ground plane, each patch antenna having a respective probe disposed between the patch antenna and the ground plane, the antenna array further comprising a transmission network connecting the respective probes to each other and to a transmitter to or from the antenna array.

4. The antenna of claim 3, wherein the antenna array is a two-by-two or a four-by-four antenna array.

5. The antenna of claim 1, wherein the antenna forms a dual band antenna structure having two rectangular patch antennas and two respective probes, wherein both patches and probes are of different dimensions.

6. The antenna of claim 5, wherein the patches antennas are disposed above the ground plane and spaced at different distances from the ground plane.

7. The antenna of claim 5, wherein the dual band antenna structure further comprises a transmission line connecting the probes to each other and to the transmitter to or from the antenna structure, the transmission line being parallel to the ground plane.

8. The antenna of claim 1, wherein the patch antenna is spaced from the ground plane by multiple layers of differing dielectric materials.

9. The antenna of claim 1, wherein a highest point of the helical shape is at a small distance predetermined d from a bottom surface of the patch antenna.

10. The antenna of claim 1, wherein the helical shape is a first predetermined distance from one edge of the patch antenna and a second predetermined distance from a second edge of the patch antenna wherein the second predetermined distance is significantly larger in relative terms to the first predetermined distance.

11. The antenna of claim 10, wherein the first predetermined distance is 0 mm from the one edge of the patch antenna.

12. The antenna of claim 1, wherein the antenna has elements of the following dimensions:
ground plane=12 cm×12 cm
patch=6.7×6.7 cm
patch height=0.95 cm
helix height=0.75 cm
distance d from helix highest point to bottom of patch=2 mm
helix diameter=1 cm
number of turns=1.3; and
wire diameter=0.5 mm.

13. The antenna of claim 1, wherein the patch antenna is comprised of a pure metallic form.

14. The antenna of claim 1, wherein the patch antenna is etched on a dielectric material.

15. The antenna of claim 1, wherein the helical shape is placed above the ground plane and connected to a short vertical section of a predetermined height that is an extension of a center conductor of a coaxial connector.

16. The antenna of claim 1, wherein the probe is a standard helix probe or a conical helix probe.

17. An antenna comprising:
a patch antenna disposed above a ground plane,
a probe disposed between the patch and the ground plane, the probe having a three dimensional shape occupying multiple planes and being substantially normal to the ground plane;
means for transmitting a signal to or from said antenna; and
means for coupling the probe to the means for transmitting, wherein the probe is adapted to be electromagnetically coupled to the patch.

18. The antenna of claim 17, wherein the antenna forms a dual band antenna structure having two rectangular patch antennas and two respective probes, wherein both patches and probes are of different dimensions.

19. The antenna of claim 8, wherein the dual band antenna structure further comprises a transmission line connecting the probes to each other and to the means for transmitting to or from the antenna structure, the transmission line being parallel to the ground plane.

20. An antenna array comprising a plurality of antennas, comprising:
a plurality of patch antennas disposed above a ground plane, each patch antenna having a respective probe disposed between the patch antenna and the ground plane and where the respective probe has a helical shape and being substantially normal to the ground plane; and
a transmission network connecting the respective probes to each other and to a transmitter to or from the antenna array and wherein the respective probes are adapted to be electromagnetically coupled to each patch antenna.
